(19) United States
(12) Patent Application Publication
(10) Pub. No.: US 2012/0200413 A1
(43) Pub. Date: Aug. 9, 2012

(54) Positive action alarm system

(76) Inventor: Doyle Spurlin, Lakeside, TX (US)

(21) Appl. No.: 13/385,171

(22) Filed: Feb. 6, 2012

Related U.S. Application Data
(60) Provisional application No. 61/462,798, filed on Feb. 7, 2011.

(51) Int. Cl. G08B 13/22

(52) U.S. Cl. 340/568.1

(57) ABSTRACT

The invention disclosed herein is an apparatus and method for protecting outdoor air conditioners and other valuables stored outside from theft. The invention is composed of an electronic circuit which sounds an alarm when a sensor cable attached to the inside of the air conditioner is severed. The components of the Positive Action alarm system are: 1) a source of 110v electricity, 2) a power switch, 3) a step down transformer to convert 110v electricity to 24v electricity, 4) a plurality of terminal blocks, 5) a red and green status light, 6) an arming switch, 7) a sensor cable, 8) a plurality of electrical contacts, and 9) an alarm circuit containing an alarm bell and alarm light. All of the components are connected by electric wire. A number of air conditioners can be protected from theft by the invention disclosed herein.

### CROSS-REFERENCE TO RELATED APPLICATIONS

This application seeks priority to and the benefit of provisional application No. 61/462,798 filed on Feb. 7, 2011 which is incorporated herein by reference as if fully set forth.

### STATEMENT REGARDING FEDERALLY SPONSORED RESEARCH OR DEVELOPMENT

No part of the invention disclosed herein was the subject of federally sponsored research or development.

### THE NAMES OF THE PARTIES TO A JOINT RESEARCH AGREEMENT

None.

### REFERENCE TO A SEQUENCE LISTING

Not applicable.

### BACKGROUND OF THE INVENTION

1. Field

The field of the invention disclosed herein is an alarm system for outdoor air conditioning units which cannot be bypassed by the thief.

2. Description of the Related Art

Theft of equipment has been a problem since the beginning of man's existence on earth. Various methods have been developed to prevent theft of equipment. Some of these methods employ an active surveillance with a guard or watchman overseeing the equipment. The guard or watchman may be physically located near the equipment or observing the equipment by way of a video camera aimed at the equipment. Other methods have been tried which use a passive method of surveillance over the equipment sought to be protected. Alarms may be attached to the equipment which emits a distinctive tone when the equipment is moved without authorization. The alarm may also send a signal to a monitor at a distant location advising that the equipment is being moved. In some cases the alarm system may be composed of lights and sirens or whistles which activate when the equipment is moved. In other situations a video camera can be aimed at the equipment to be protected and a continuous or intermittent image may be sent to a video recorder where the image is preserved for later viewing. Other systems require a motion detecting sensor which detects motion in an area around the site to be protected. Once the motion is detected a signal may be sent to a monitor at a distant location and/or alarms may be activated. All of the foregoing alarm systems may be overcome. Moreover, these alarm systems are expensive to install and operate.

Recently, the incidence of theft of outdoor air conditioning units has spiraled upward. Air conditioning units are expensive and can readily be resold as a complete unit or sold as parts. Air conditioning units also contain large quantities of valuable copper wire and tubing which can be removed and sold to a copper recycling operation. Theft of outdoor air conditioning units can be accomplished in a few minutes. First the electric power to the air conditioning unit is disconnected. Then the thief cuts all of the hoses freeing the unit from any connection. The air conditioning unit is then loaded into a truck and spirited away. What is needed in the art is a device and method which sounds an alarm or series of alarms when the thief cuts the electric power to the air conditioning unit.

### BRIEF DESCRIPTION OF THE INVENTION

The invention disclosed herein is a device and method which sounds an alarm or series of alarms when a thief cuts the electric power to an air conditioning unit. Specifically, the invention disclosed herein is a Positive Action Alarm system which consists of an alarm panel which contains the electronic circuitry for the alarm box and a sensor wire which is run through the electric supply conduit of the air conditioning unit and exits through the air conditioning unit by the low pressure line or the thermostat wire. When the sensor wire is cut, the alarm is activated and can only be turned off from inside the building to which the air conditioner is associated.

### BRIEF DESCRIPTION OF THE SEVERAL VIEWS OF THE INVENTION

A better understanding of the Positive Action Alarm System disclosed herein may be had by examination of the following figures/drawings:

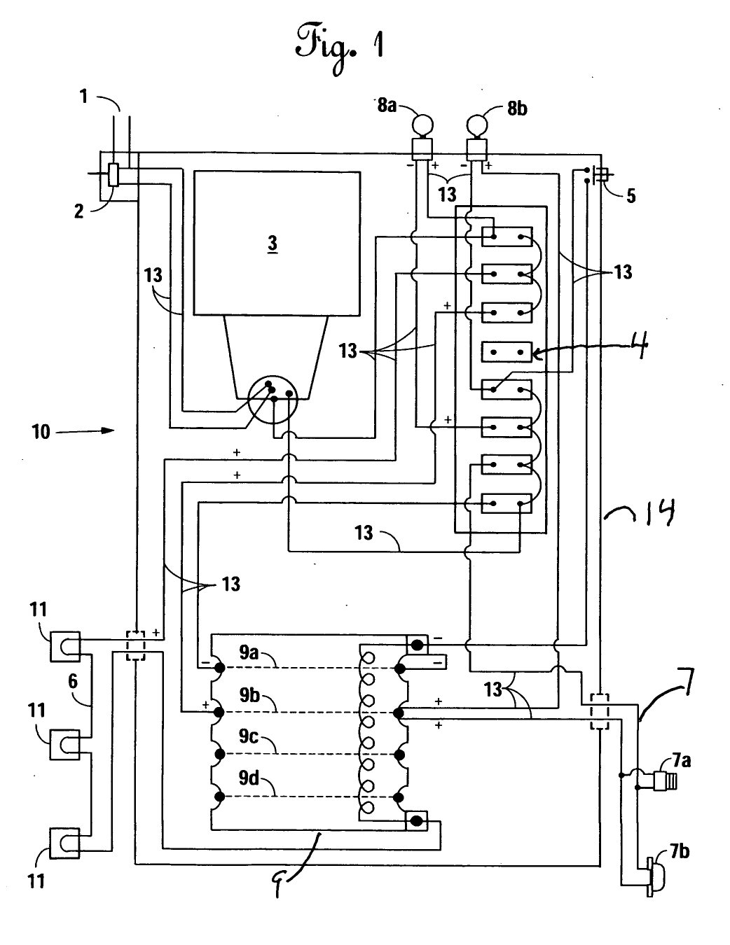

FIG. 1 is a wiring schematic with no electric power to the invention disclosed herein;

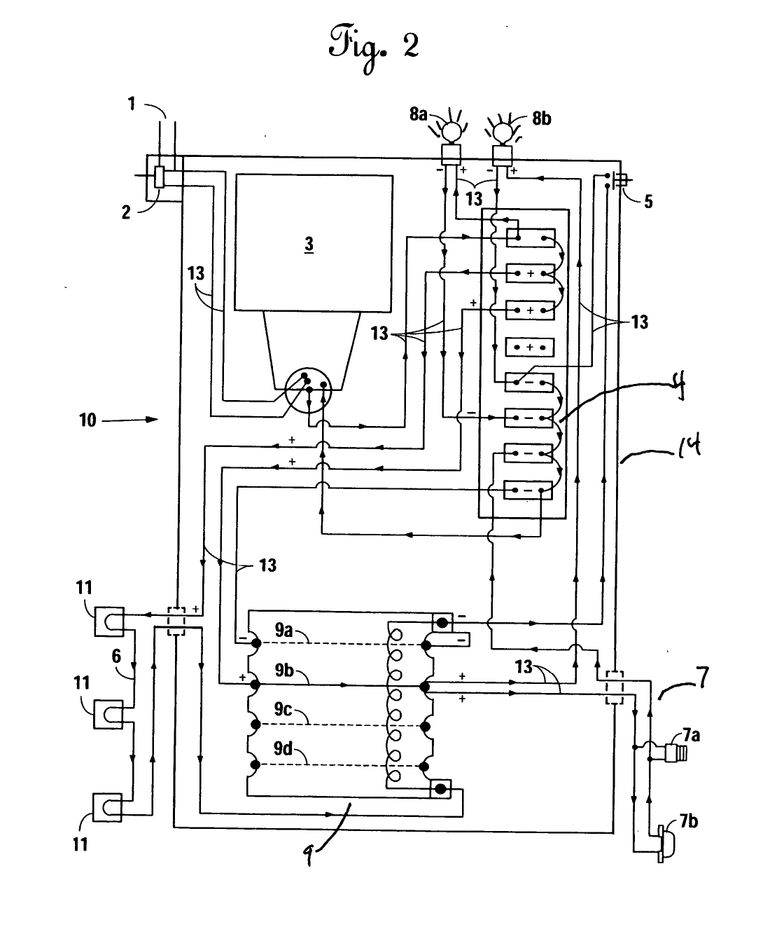

FIG. 2 is a wiring schematic with electric power to the invention disclosed herein;

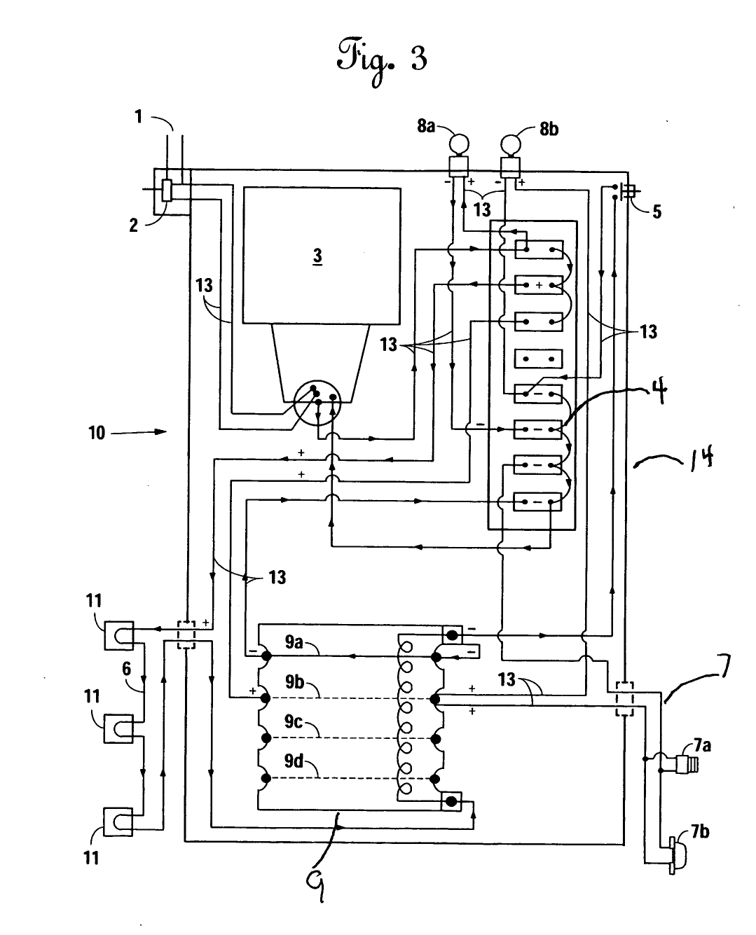

FIG. 3 is a wiring schematic of the activated armed alarm system disclosed herein.

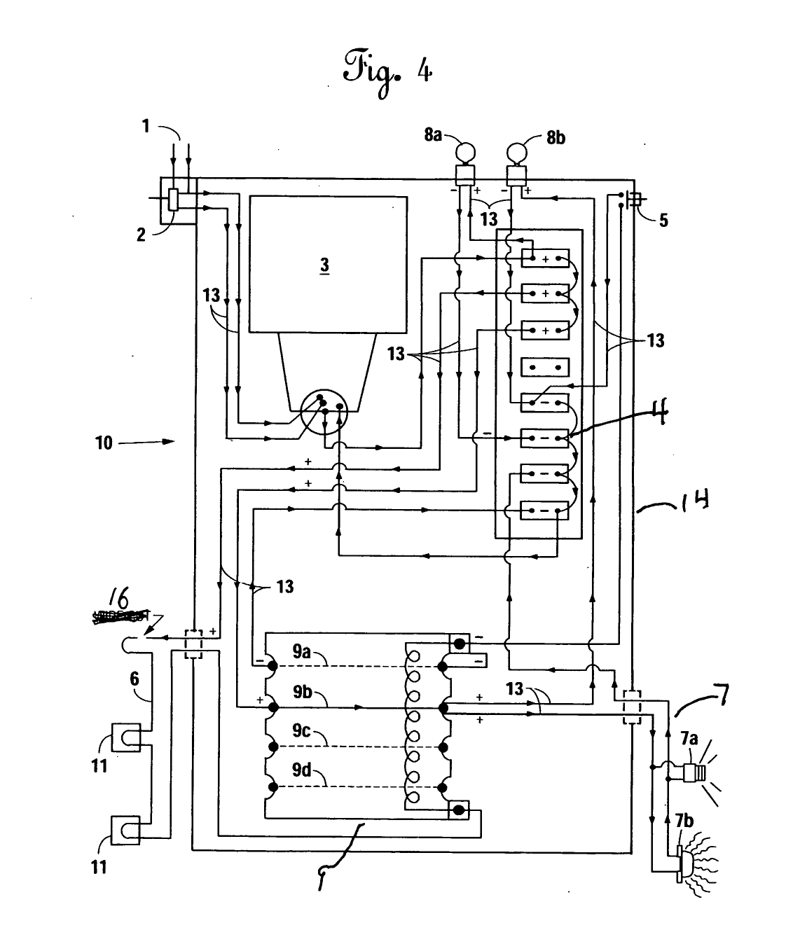

FIG. 4 is a wiring schematic of the armed alarm system with the sensor cable severed;

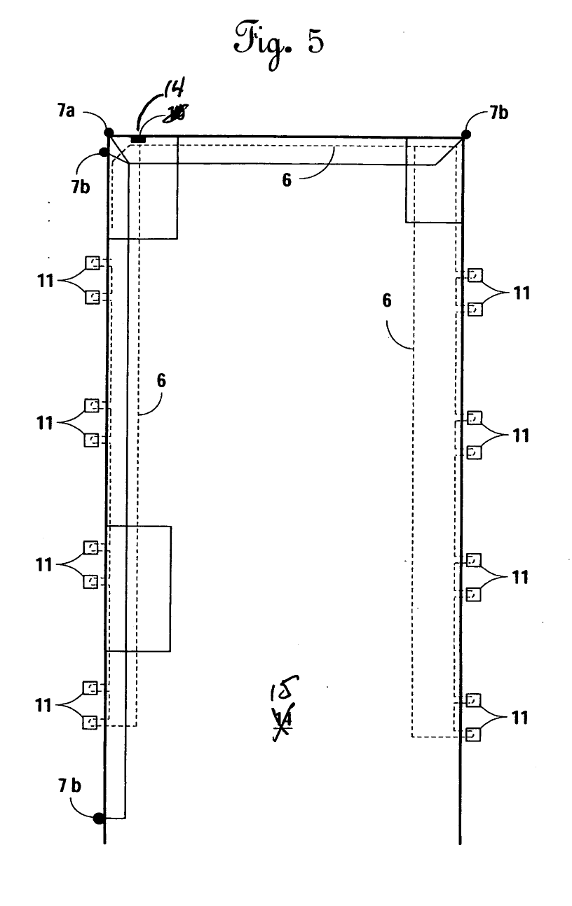

FIG. 5 is a wiring diagram linking several air conditioning units to the alarm box.

### DETAILED DESCRIPTION OF THE INVENTION

The invention disclosed herein is an apparatus and method for protecting outdoor air conditioning units by an alarm system which would activate in the event of attempted theft. Specifically, as shown in FIG. 1, the Positive Action Alarm System 10 disclosed herein is composed of a main power switch 2 attached by electric wire 13 to a source of electricity 1, a step-down transformer 3 which converts electricity of 110 volts to 24 volts, a multiple number of wire connectors in one or more terminal blocks 4, a keyed power alarm activation switch 5, a sensor wire 6 which connects the air conditioning units 11 to the Positive Action Alarm System 10, a plurality of electrical contacts 9a, 9b, 9c, 9d which in this embodiment electrical contacts 9a and 9d are normally open and electrical contacts 9b and 9c are normally closed. An alarm circuit which consists of a bell 7b, light 7a or other warning device which activates when the Positive Action Alarm System 10 detects a theft and status lights 8a, 8b which illuminate when the Positive Action Alarm System 10 has electrical power and the alarm system is activated. All of the components of the Positive Action alarm 10 system are connected by electric wire 13 to form an electric circuit. All of the above components are contained within the alarm box 14. The sensor wire 6 extends from the alarm box 14 to the air conditioning units 11. The alarm box 14 is mounted inside a building or other structure to make it inaccessible to a thief and preventing the thief from easily disarming the Positive Action Alarm System 10.

FIG. 2 is a wiring diagram of the Positive Action alarm System 10. The main power switch 2 is wired to the step down transformer 2 which in turn is connected by wire to one or more terminal blocks 4. The terminal blocks 4 are connected by wire to the system arming switch 5 and the green and red status lights 8a and 8b, respectively. The terminal block 4 is also connected by wire to the sensor wire 6 and the contacts 9a, 9b, 9c, 9d. The contacts 9a, 9b, 9c, 9d are connected to the green and red status lights 8a and 8b, respectively and to the alarm circuit which is connected to the bell 7b, alarm light 7a or other warning device. The sensor wire 6 should be run through the electric supply conduit of the air conditioner 11 and exit the air conditioner by the low pressure line or the thermostat wire. The sensor wire 6 should be installed to be taut so that if the sensor wire 6 is severed, it cannot be reconnected. In this manner, the Positive Action Alarm System 10 cannot be turned off without entry into the building 15 and access to the alarm box 14. When electricity 1 enters the system by activating the main power switch 2, the step down transformer 3 converts the 110 volt electricity to 24 volt electricity and sends the 24 volt electricity to the terminal blocks 4 which is distributed to the system. At this time the green and red status lights 8a and 8b, respectively are illuminated and the alarm 7b sounds. At this time, the sensor wire 6 is energized.

As shown in FIG. 3, when the main power switch 2 is turned “on” 110 volts of electricity from the power source 1 enter the step down transformer 3 which converts the electricity to 24 volts. The electricity (24 volts) goes to the terminal blocks 4. From the terminal blocks 4, the electricity (24 volts) energizes the sensor wire 6, the alarm circuit 7 and the green and red status lights 8a and 8b, respectively. At this time the red and green status lights 8a and 8b, respectively are illuminated and the alarm circuit 7 is activated sounding the alarms 7a, 7b and illuminating the lights, if any.

When the Positive Action Alarm System 10 is armed by turning on the system arming switch 5, a circuit is made through the terminal block 4 as shown in FIG. 4. The contactor 9 is activated closing contactors 9a and 9d. Contactors 3b and 3c open at the same time silencing the alarm 7b and extinguishing the red status light 8b. The green status light 8a is still illuminated indicating that the system is armed. Cutting the sensor cord 6 will now cause the alarms to sound.

When the Positive Action Alarm System 10 is activated by severing the sensor wire 6 at any location along its path 16, contact 9b is closed which sends a flow of electricity (24 volts) activating the alarm circuit 7 and illuminating the red status light 8b. At this time the alarms are sounding 7b and lights 7a are flashing. The only way to disarm the system is by way of the arming switch 5. Turning the arming switch 5 to the off position deactivates the Positive Action Alarm System 10 silencing the alarms 7b and turning off the lights 7a.

The Positive Action Alarm System 10 may be used to protect a large number of air conditioning units 11 as shown in FIG. 5. The alarm box 14 is attached to the inside of the building 15 and the sensor wire 6 is run outside the building to connect many different air conditioning units 11. Additional alarm bells and lights 7a, 7b may be added to the Positive Action alarm System 10 to provide additional deterrence and notification that the sensor wire 6 has been severed.

The Positive Action Alarm System may be designed and constructed to provide security for many types of stationary objects. In one embodiment the Positive Action Alarm system could be adapted to secure the doors and windows of a storage building, shed, barn, store or home. In another embodiment the Positive Action Alarm System could be adapted to secure vehicles in storage such as cars, boats and/or airplanes. In another embodiment of the invention disclosed herein, the Positive Action Alarm System could be used by a retailer to provide security for items displayed outside the building. In other embodiments of the Positive Action Alarm System many different types of alarms could be incorporated. Alarms such as bells, whistles, horns, sirens, flashing lights, strobe lights and colored lights may be added to the Positive Action Alarm System. A camera could also be attached to the Positive Action Alarm System. When the sensor wire of the Positive Action Alarm System is severed a still or video picture of the thief could be taken and preserved. In another embodiment, severing the alarm could send a message to a manned monitoring station. Law enforcement officers could be summoned to the location of the severed sensor wire. There are numerous configurations and embodiments suitable for the Positive Action Alarm System which are included in this disclosure as described by the specification and appended claims.

I claim:

1. An apparatus containing an electric circuit designed to prevent theft of outdoor air conditioners comprising:
an 110v source of electricity;
a power switch;
an 110v to 24v step down transformer;
a plurality of terminal block electric connectors;
a system activation warning light;
a system alarm activation warning light;
a system arming switch;
a sensor cable attached to the interior of said air conditioners;
a plurality of electrical contacts;
an alarm light
an alarm bell;
Whereby said 110v source of electricity is wireably connected to said power switch and wireably connected to said 110v to 24v step down transformer which is wireably connected to said plurality of terminal block electric connectors which are wireably connected to said system activation warning light, said system arming switch, said sensor cable, said plurality of electrical contacts, said alarm light, and said alarm bell so that when the sensor cable is cut the said alarm light and said alarm bell are activated warning the premises owner of a potential theft of the said outdoor air conditioners.

2. An apparatus containing an electric circuit designed to prevent theft of outdoor air conditioners comprising:
an 110v source of electricity;
a power switch;
an 110v to 24v step down transformer;
a plurality of terminal block electric connectors;
a system activation warning light;
a system alarm activation warning light;
a system arming switch;
a sensor cable attached to the interior of the said air conditioners;
a plurality of electrical contacts;
an alarm light
an alarm bell;
Whereby, said 110v source of electricity, said power switch, said 110 to 24v step down transformer; said plurality of terminal block electrical connectors, said system activation warning light, said alarm activation warning light, said system arming switch, said sensor cable attached to the interior of said air conditioners, said plurality of electrical contacts, said alarm light and said alarm bell are connected into an electrical circuit which is configured to activate the said alarm light and alarm bell when said sensor cable is severed.

3. A system and method for theft prevention of outdoor air conditioners comprising steps for:
building an electric circuit;
including in said electric circuit a source of 110v electricity, a power switch, a 110v to 24v step down transformer, a plurality of terminal block connectors, a system activation light, an alarm activation light, a system arming switch, a sensor cable attached to the interior of said air conditioners, a plurality of electrical contacts, an alarm light and an alarm bell;
configuring said electrical circuit and said source of 110v electricity, said power switch, said 110 v to 24v step down transformer, said plurality of terminal block connectors, said system activation light, said alarm activation light, said system arming switch, said sensor cable attached to the interior of said air conditioners, said plurality of electrical contacts, said alarm light and said alarm bell so that when said sensor cable is severed during a theft, the alarm bell and alarm light are activated.
